(19) United States
(12) Patent Application Publication
(10) Pub. No.: US 2020/0122462 A1
(43) Pub. Date: Apr. 23, 2020

(54) LIQUID EJECTING HEAD, HEAD HOLDING MEMBER, LIQUID EJECTING APPARATUS, AND METHOD OF MANUFACTURING LIQUID EJECTING APPARATUS

(71) Applicant: SEIKO EPSON CORPORATION, Tokyo (JP)

(72) Inventor: Hiroyuki HAGIWARA, Matsumoto-shi (JP)

(21) Appl. No.: 16/657,255

(22) Filed: Oct. 18, 2019

(30) Foreign Application Priority Data
Oct. 22, 2018 (JP) 2018-198208

(51) Int. Cl. B41J 2/145

(52) U.S. Cl. CPC B41J 2/145

(57) ABSTRACT

A screw hole for fixing to a head holding member that holds a liquid ejecting head is provided, and the screw hole has openings respectively open to one side which is a nozzle forming surface side in a first direction that is a direction intersecting a nozzle forming surface and to another side opposite to the nozzle forming surface side.

The present application is based on, and claims priority from JP Application Serial Number 2018-198208, filed Oct. 22, 2018, the disclosure of which is hereby incorporated by reference herein in its entirety.

### BACKGROUND

### 1. Technical Field

The present disclosure relates to a liquid ejecting head such as an ink jet recording head, a head holding member, a liquid ejecting apparatus, and a method of manufacturing a liquid ejecting apparatus.

### 2. Related Art

A liquid ejecting apparatus is an apparatus that includes a liquid ejecting head and ejects (discharges) various types of liquid as droplets from the liquid ejecting head. As the liquid ejecting apparatus, for example, there is an image recording apparatus such as an ink jet printer or an ink jet plotter. Recently, the apparatus has been applied to various manufacturing apparatuses by taking an advantage that a very small amount of liquid can be accurately landed at a predetermined position. For example, the apparatus is applied to a display manufacturing apparatus for manufacturing a color filter of a liquid crystal display or the like, an electrode forming apparatus for forming an electrode of an organic electro luminescence (EL) display, a field emission display (FED), or the like, and a chip manufacturing apparatus for manufacturing a biochip. A recording head for the image recording apparatus ejects a liquid containing a coloring material, and a coloring material ejecting head for the display manufacturing apparatus ejects a liquid containing each color material such as red (R), green (G), or blue (B). In addition, an electrode material ejecting head for the electrode forming apparatus ejects a liquid containing an electrode material, and a bioorganic matter ejecting head for the chip manufacturing apparatus ejects a liquid containing a bioorganic matter.

Among liquid ejecting apparatuses, there are some which adopt a unitized one in which a plurality of liquid ejecting heads are fixed side by side on a head holding member. (for example, see JP-A-2012-040731). In JP-A-2012-040731, there is disclosed a configuration in which a liquid ejecting head is fixed to a head holding member called a sub-carriage by a screw via a relay member, and the liquid ejecting head and the relay member are screwed in advance, and the relay member to which the liquid ejecting head is fixed is used as a fixing surface of the head holding member. In the configuration, the relay member and the head holding member are fixed by inserting a fixing member having a male screw such as a bolt or a screw from a side opposite to a nozzle forming surface side of the liquid ejecting head toward a liquid ejecting head side through a fastening hole penetrating a bottom portion of the head holding member. Hereinafter, an operation of fixing a liquid ejecting head to a head holding member by a fixing member such as a screw is appropriately referred to as a screwing operation. The screwing operation is not limited to when manufacturing a liquid ejecting apparatus, and is also performed when repairing or replacing the liquid ejecting head held by the head holding member.

Meanwhile, there are a case of performing a screwing step from one side in a first direction intersecting the nozzle forming surface on which nozzles of the liquid ejecting head are formed, that is, a nozzle forming surface side, and a case of performing a screwing step from the other side in the first direction, that is, a side opposite to the nozzle forming surface, according to a fixing mode of the liquid ejecting head to the head holding member depending on the specification and an internal structure of the liquid ejecting apparatus, and according to the working conditions of the screwing step in manufacturing or repairing, and the like. In recent years, it has been required to be able to perform these screwing steps from both sides.

### SUMMARY

According to an aspect of the present disclosure, there is provided a liquid ejecting head including: a nozzle forming surface on which a nozzle ejecting a liquid is formed; an energy generating element that generates energy for ejecting the liquid from the nozzle; and a screw hole for fixing to a head holding member that holds the liquid ejecting head, in which the screw hole has openings respectively open to one side which is a nozzle forming surface side in a first direction intersecting the nozzle forming surface and to another side opposite to the nozzle forming surface side (first configuration). According to the present disclosure, when the liquid ejecting head is fixed to the head holding member, screwing operations can be respectively performed from one side and the other side in the first direction.

In the first configuration, the one side of the screw hole may be provided with a first abutting portion abutting against the head holding member, and the other side of the screw hole may be provided with a second abutting portion abutting against a head portion of a screw configured to be screwed into a fixing screw hole formed in the head holding member (second configuration). According to the configuration, when the liquid ejecting head is fixed to the head holding member, the screwing operation can be performed from one side and the other side in the first direction respectively.

In addition, in the first configuration, a standard of a male screw portion in the screw may differ between when a head portion of a screw is located on the one side of the screw hole and when the head portion of the screw is located on the other side of the screw hole (third configuration).

According to the configuration, it is sufficient to use a standard screw depending on whether the screwing operation is performed from one side or the other side of the screw hole in the first direction. Therefore, the operator is less likely to be confused about the selection of a size of the screw, that is, a thickness and an outer diameter of the male screw portion, and workability is further improved.

In addition, in the first configuration or the second configuration, a size of the opening provided in a second abutting portion may be set to a size such that a male screw portion of a second screw, an outer diameter of the male screw portion being smaller than that of a first screw configured to be screwed into the screw hole, is configured to be inserted into the opening, and a head portion of the second screw is configured to be locked to a second abutting portion (fourth configuration).

According to the configuration, the second screw can fix the liquid ejecting head to the head holding member without the second screw falling into the screw hole.

According to another aspect of the present disclosure, there is provided a liquid ejecting head configured to be fixed to a first head holding member having an insertion hole into which a first screw for holding the liquid ejecting head is configured to be inserted, and a second head holding member having a fixing screw hole into which a second screw different from the first screw is configured to be screwed at a position corresponding to the insertion hole, the head including: a nozzle forming surface on which a nozzle ejecting a liquid is formed; an energy generating element that generates energy for ejecting the liquid from the nozzle; and a screw hole into which the first screw is configured to be screwed, in which the screw hole has openings respectively open to one side which is a nozzle forming surface side in a first direction intersecting the nozzle forming surface and to another side opposite to the nozzle forming surface side (fifth configuration).

According to the present disclosure, when the liquid ejecting head is fixed to the head holding member, screwing operations can be respectively performed from one side and the other side in the first direction.

In addition, in the fifth configuration, the second screw having a male screw portion of which an outer diameter is smaller than that of the first screw, may be inserted into the screw hole, and the inserted second screw may be configured to be screwed into the fixing screw hole of the second head holding member (sixth configuration).

The screwing operation can be performed using the screw hole from one side and the other side in the first direction, respectively, that is, it is not necessary to use different screw holes in each screw-fastening operation. Therefore, it contributes to the miniaturization of the liquid ejecting head, accordingly.

According to still another aspect of the present disclosure, there is provided a liquid ejecting head configured to be fixed to a first head holding member having an insertion hole into which a first screw of a first standard is configured to be inserted, and a second head holding member having a fixing screw hole into which a second screw of a second standard having a male screw portion of which an outer diameter is smaller than that of the first standard, is configured to be screwed at a position corresponding to the insertion hole, the head including: a nozzle forming surface on which a nozzle ejecting a liquid is formed; an energy generating element that generates energy for ejecting the liquid from the nozzle; and a screw hole into which the second screw is configured to be inserted and the first screw is configured to be screwed, in which the screw hole has openings respectively open to one side which is a nozzle forming surface side in a first direction intersecting the nozzle forming surface and to another side opposite to the nozzle forming surface side (seventh configuration).

According to the present disclosure, when the liquid ejecting head is fixed to the head holding member, screwing operations can be respectively performed from one side and the other side in the first direction.

In any one of the first to seventh configurations, the screw hole may have a positioning hole having an inner diameter smaller an inner diameter of the screw hole (eighth configuration).

According to the configuration, the liquid ejecting head can be positioned by inserting the positioning pin or the like into the screw hole.

In any one of the first to eighth configurations, in plan view as viewed in the first direction, a first portion of which a center line parallel to a long side of a rectangle having a minimum area including the nozzle forming surface passes a center thereof, and a second portion deviated from the center line, and a third portion diagonally opposite to the second portion with the center in between may be arranged in a second direction parallel to the long side, and the screw hole may be provided at each of an end portion of the second portion opposite to the first portion in the second direction, and an end portion of the third portion opposite to the first portion in the second direction (ninth configuration).

According to the configuration, when a plurality of liquid ejecting heads are linearly arranged in the second direction, the second portion and the third portion of the adjacent liquid ejecting heads can be disposed without interference. In addition, since the screw holes are respectively formed at the end portions of the second and third portions on the side opposite to the first portion in the second direction, a distance between the centers of the screw holes at both end portions can be made longer. Therefore, the liquid ejecting head in the head holding member can be disposed with higher accuracy.

According to still another aspect of the present disclosure, there is provided a head holding member to which the liquid ejecting head according to any one of the first to ninth configurations is fixed, the member including an insertion hole having an inner diameter larger than an inner diameter of the screw hole at a position overlapping the screw hole when viewed in the first direction (tenth configuration).

According to the configuration, the liquid ejecting head can be fixed to the head holding member by inserting a screw from the insertion hole and screwing the screw into the screw hole. Further, since the insertion hole does not interfere with the screw, the liquid ejecting head can be fixed to the head holding member in a stable state.

In addition, in the tenth configuration, a surface opposite to a surface holding the liquid ejecting head may have a recess portion in which a head portion of a screw inserted into the insertion hole and screwed into the screw hole is accommodated (eleventh configuration).

According to the configuration, it is possible to prevent the head portion of the screw from protruding from the surface on the side opposite to the surface holding the liquid ejecting head.

According to still another aspect of the present disclosure, there is provided a head holding member to which the liquid ejecting head according to any one of the first to ninth configurations is fixed, the member including a fixing screw hole which is set to have an inner diameter smaller than an inner diameter of the screw hole at a position overlapping the screw hole when viewed in the first direction, and into which a screw inserted into the screw hole is configured to be screwed (twelfth configuration).

According to the present disclosure, the liquid ejecting head can be fixed to the head holding member by screwing the screw inserted into the screw hole into the fixing screw hole.

According to still another aspect of the present disclosure, there is provided a liquid ejecting apparatus including: a liquid ejecting head that includes a nozzle forming surface on which a nozzle ejecting a liquid is formed, an energy generating element generating energy for ejecting the liquid from the nozzle, and a through-hole into which a screw is inserted; a head holding member to which the liquid ejecting head is fixed and which includes an insertion hole communicating with the through-hole; and a screw inserted into the insertion hole, in which a female screw is formed on an inner peripheral surface of the through-hole, and the screw is screwed into the through-hole, and the liquid ejecting head pinches the head holding member with a head portion of the screw (thirteen configuration).

According to the present disclosure, it is possible to fix the liquid ejecting head to the head holding member by screwing the screw inserted into the insertion hole into the female screw formed on the inner peripheral surface of the through-hole.

According to still another aspect of the present disclosure, there is provided a liquid ejecting apparatus including: a liquid ejecting head that includes a nozzle forming surface on which a nozzle ejecting a liquid is formed, an energy generating element generating energy for ejecting the liquid from the nozzle, and a through-hole into which a screw is inserted; a head holding member to which the liquid ejecting head is fixed and which includes a fixing screw hole communicating with the through-hole; and a screw inserted into the through-hole and screwed into the fixing screw hole, in which a female screw is formed on an inner peripheral surface of the through-hole, and the liquid ejecting head is pinched by the head holding member with a head portion of the screw (fourteen configuration).

According to the present disclosure, the liquid ejecting head can be fixed to the head holding member by screwing the screw inserted into the through-hole into the fixing screw hole without being screwed into the female screw.

According to still another aspect of the present disclosure, there is provided a method of manufacturing a liquid ejecting apparatus having the thirteen configuration or the fourteen configuration, the method including: a screw specifying step of specifying a screw that fixes the liquid ejecting head to the head holding member; and a screw inserting step of inserting the screw into the screw hole from an opening on a side corresponding to the screw specified in the screw specifying step among the openings of the screw hole which is the through-hole in the first direction (first method).

According to the present disclosure, when the liquid ejecting head is fixed to the head holding member, the screwing operation can be performed from one side and the other side respectively in the first direction using the screw holes.

In the first method, in the screw specifying step, when a target to which the liquid ejecting head is to be fixed is a first head holding member having an insertion hole into which a first screw configured to be screwed into the screw hole is configured to be inserted, the first screw may be specified as the screw, and when the target to which the liquid ejecting head is to be fixed is a second head holding member having a fixing screw hole into which a second screw, where an outer diameter of a male screw portion is smaller than an outer diameter of a male screw portion of the first screw is capable of to be screwed, the second screw may be specified as the screw (second method).

According to the method, the fixing screw is determined in advance in accordance with the fixing target of the liquid ejecting head, so that an operator is less likely to be confused about the selection of screws and workability is further improved.

In the second method, when the screw specified in the screw specifying step is the first screw, in the screw inserting step, the first screw may be screwed into the screw hole from the one side opening in the first direction through the insertion hole, and the first head holding member may be pinched between a head portion of the first screw and the liquid ejecting head, and when the screw specified in the screw specifying step is the second screw, in the screw inserting step, the second screw may be inserted into the screw hole from the other side opening in the first direction, and the liquid ejecting head may be pinched between a head portion of the second screw and the first head holding member (third method).

According to the method, even when the screws are different according to the fixing target of the liquid ejecting head, the liquid ejecting head can be fixed to the head holding member using respective screws.

In any one of the first to third methods, before the screw inserting step, a positioning pin inserting step of inserting a positioning pin for defining a position of the liquid ejecting head into the screw hole, and a positioning step of defining the position of the liquid ejecting head by inserting the positioning pin may be provided (fourth method).

According to the method, the screw hole can be used as a positioning hole, so the liquid ejecting head can be positioned.

### BRIEF DESCRIPTION OF THE DRAWINGS

FIG. 1 is a schematic view for explaining a configuration of an aspect of a liquid ejecting apparatus.

FIG. 2 is a perspective view for explaining a configuration of an aspect of a liquid ejecting unit.

FIG. 3 is a front view for explaining a configuration of an aspect of a liquid ejecting module.

FIG. 4 is a perspective view for explaining a configuration of an aspect of the liquid ejecting module.

FIG. 5 is a perspective view for explaining a configuration of an aspect of the liquid ejecting head.

FIG. 6 is an exploded perspective view for explaining a configuration of an aspect of the liquid ejecting head.

FIG. 7 is a plan view for explaining a configuration of an aspect of the liquid ejecting head.

FIG. 8 is a side view for explaining a configuration of an aspect of the liquid ejecting head.

FIG. 9 is a sectional view for explaining a configuration of an aspect of a drive section.

FIG. 10 is a sectional view illustrating a peripheral structure of a first flange portion when the liquid ejecting head is fixed to a second head holding member.

FIG. 11 is a sectional view illustrating the peripheral structure of the first flange portion when the liquid ejecting head is fixed to the first head holding member.

FIG. 12 is a flowchart for explaining a method of manufacturing a liquid ejecting apparatus.

FIG. 13 is a step view for explaining a step of fixing the liquid ejecting head to the second head holding member.

FIG. 14 is a step view for explaining a step of fixing the liquid ejecting head to the second head holding member.

FIG. 15 is a step view for explaining a step of fixing the liquid ejecting head to the first head holding member.

FIG. 16 is a step view for explaining a step of fixing the liquid ejecting head to the first head holding member.

FIG. 17 is a sectional view illustrating a peripheral structure on a first flange portion side for explaining a positioning state of the liquid ejecting head by a positioning jig.

FIG. 18 is a flowchart for explaining a positioning step of the liquid ejecting head by the positioning jig.

### DESCRIPTION OF EXEMPLARY EMBODIMENTS

Hereinafter, embodiments for executing the present disclosure will be described with reference to the attached drawings. In the embodiments described below, various limitations are given as preferable specific examples of the present disclosure, but the scope of the present disclosure is not limited to the aspects as long as there is no description to specifically limit the present disclosure in the following description. In the following description, an ink jet recording apparatus (hereinafter, referred to as a printer 1) equipped with a liquid ejecting head 20 will be described as an example of the liquid ejecting apparatus of the present disclosure.

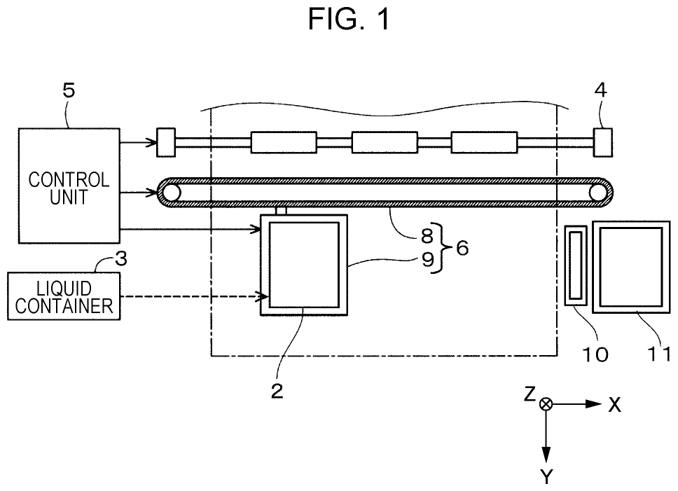

FIG. 1 is an explanatory view schematically illustrating a configuration of the printer 1 according to the present disclosure. The printer 1 is an ink jet printing apparatus that ejects droplets of ink, which is a type of liquid, to be landed onto a print medium M, and prints an image or the like by an arrangement of dots formed on the print medium M. The printer 1 according to the present embodiment performs printing on various types of print media M including a print target of any material such as a resin film or cloth in addition to print paper. In the following, among X, Y, and Z directions orthogonal to one another, a moving direction (in other words, a main scanning direction) of a liquid ejecting unit 2 described later is the X direction, and a transporting direction (in other words, a sub-scanning direction) of the print medium M orthogonal to the main scanning direction is taken as the Y direction (corresponding to a second direction in the present disclosure). A plane parallel to a nozzle forming surface on which nozzles 35 of the liquid ejecting unit 2 are formed is taken as an XY plane, and a direction intersecting (orthogonal in the present embodiment) the nozzle forming surface, that is, the XY plane is taken as the Z direction (corresponding to a first direction in the present disclosure).

The printer 1 includes a liquid container 3, a transport mechanism 4 feeding the print medium M, a control unit 5, a carriage moving mechanism 6, and the liquid ejecting unit 2. The liquid container 3 separately stores plural types (for example, plural colors) of ink ejected from the liquid ejecting unit 2. As the liquid container 3, a bag-like ink pack formed of a flexible film, an ink tank capable of refilling ink, or the like can be used. The control unit 5 includes a processing circuit such as a central processing unit (CPU) or a field programmable gate array (FPGA) and a storage circuit such as a semiconductor memory, and integrally controls the transport mechanism 4, the carriage moving mechanism 6, the liquid ejecting unit 2, and the like. The transport mechanism 4 operates under the control of the control unit 5 and feeds the print medium M in the Y direction that is the transporting direction. The carriage moving mechanism 6 includes a transport belt 8 stretched in the X direction across a print range of the print medium M, and a carriage 9 that accommodates the liquid ejecting unit 2 and is fixed to the transport belt 8. The carriage moving mechanism 6 operates under the control of the control unit 5 and causes the liquid ejecting unit 2 mounted on the carriage 9 to reciprocate along a guide rail (not illustrated) in the X direction that is the main scanning direction. The liquid container 3 can be mounted on the carriage 9 together with the liquid ejecting unit 2.

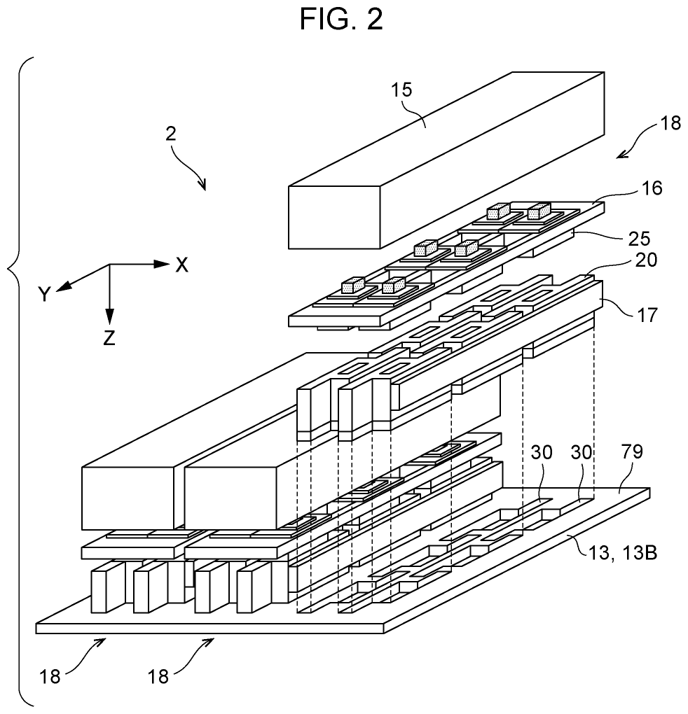

A wiper 10 is provided as a wiping member for wiping the nozzle forming surface (described later), which is a surface on which an opening of the nozzle 35 of the liquid ejecting unit 2 is formed, in a region on one side (right side in FIG. 2) in the main scanning direction of the liquid ejecting unit 2. The wiper 10 is configured of, for example, a member having elasticity and flexibility such as rubber or an elastomer. In the wiping operation, the nozzle forming surface is wiped by the wiper 10 when the wiper 10 and the nozzle forming surface move relative to each other in a state where a tip portion of the wiper 10 comes into contact with the nozzle forming surface. In addition, as a mechanism for wiping the nozzle forming surface, for example, well-known various structures, such as a wiping structure with a sheet-like wiper of nonwoven fabric, can be adopted.

A cap 11 is disposed adjacent to the wiper 10 at a home position that is a standby position of the carriage 9. The cap 11 is formed in a tray shape which enables the cap 11 to abut against the nozzle forming surface of the liquid ejecting unit 2. In the cap 11, a space in the cap 11 functions as a sealed space, and in a state where the nozzles 35 (described later) of the liquid ejecting unit 2 faces the sealed space, the cap 11 is configured to be in close contact with the nozzle forming surface. In addition, a pump is coupled to the cap 11 via a waste liquid tube (not illustrated), and an inside of the sealed space of the cap 11 can be negatively pressurized by driving of the pump.

FIG. 2 is a perspective view for explaining an aspect of the liquid ejecting unit 2 in the present embodiment. In the drawing, one of three liquid ejecting modules 18 is illustrated in a disassembled state. The liquid ejecting unit 2 in the present embodiment includes a head holding member 13 and a plurality of liquid ejecting modules 18. The head holding member 13 is a plate-like member that supports the plurality of liquid ejecting modules 18. The plurality of liquid ejecting modules 18 are fixed to the head holding member 13 in a state of being aligned in the X direction. Each liquid ejecting module 18 includes a coupling unit 15, a support member 16, a distribution flow path 17, and a plurality of (6 in the present embodiment) liquid ejecting heads 20. The number of liquid ejecting modules 18 constituting the liquid ejecting unit 2 and the number of liquid ejecting heads 20 constituting the liquid ejecting module 18 are not limited to those exemplified in the present embodiment. Further, as the head holding member 13, there are two types of a first head holding member 13A having an insertion hole 86 into which a fixing screw 85 (one type of a screw, a first screw, or a screw of a first standard according to the present disclosure) which is described later can be inserted, and a second head holding member 13B having a fixing screw hole 62 into which a fastening screw 71 (one type of a screw, a second screw, or a screw of a second standard according to the present disclosure) can be screwed at a position corresponding to the insertion hole 86. The liquid ejecting head 20 is configured to be fixed to any one of these head holding members 13A and 13B. Details of this point will be described later.

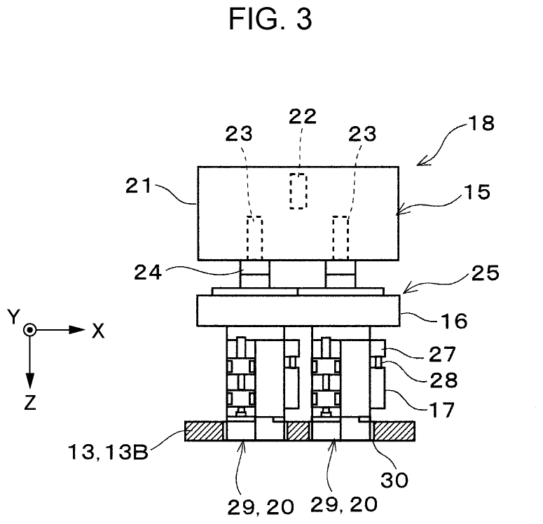

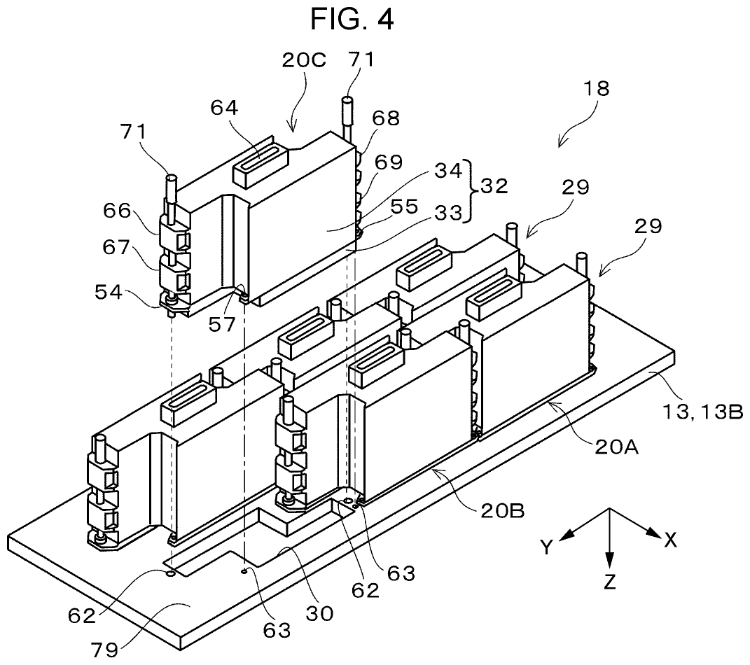

FIG. 3 is a front view illustrating a configuration of an aspect of the liquid ejecting module 18. FIG. 4 is a perspective view of the liquid ejecting module 18. In FIG. 4, the liquid ejecting head 20 and the head holding member 13 of the liquid ejecting module 18 are illustrated, and the illustration of the other configuration members is omitted. FIGS. 3 and 4 illustrate one of the liquid ejecting modules 18 as a representative, and the other liquid ejecting modules 18 have the same configuration.

For the liquid ejecting modules 18 in the present embodiment, a plurality of liquid ejecting modules 18 are disposed in two rows in the X direction on the plate-like support member 16 positioned directly below the coupling unit 15, and the distribution flow paths 17 are disposed in the sides of the plurality of liquid ejecting modules 18. The distribution flow path 17 is a configuration member having a flow path formed therein for distributing the ink supplied from the liquid container 3 to each of the plurality of liquid ejecting heads 20 of the liquid ejecting module 18. In the present embodiment, the distribution flow paths 17 are formed to be elongated in the Y direction, and are commonly provided in the three liquid ejecting heads 20.

The coupling unit 15 includes a casing 21, a relay substrate 22, and a plurality of drive substrates 23. The casing 21 is a substantially box-shaped structure accommodating the relay substrate 22 and the plurality of drive substrates 23. Each drive substrate 23 is a wiring substrate corresponding to each liquid ejecting module 18. A signal generation circuit generating a drive signal for driving a piezoelectric element 43, which is described later, is mounted on the drive substrate 23. A control signal for specifying whether to eject ink for each nozzle and a power supply voltage are supplied from the drive substrate 23 to the liquid ejecting module 18 together with the drive signal. The relay substrate 22 is a wiring substrate for relaying an electric signal and the power supply voltage between the control unit 5 and the plurality of drive substrates 23, and is shared by the plurality of liquid ejecting modules 18. A coupler 24 electrically coupled to each drive substrate 23 is provided on a bottom surface of the casing 21.

The liquid ejecting module 18 includes the liquid ejecting head 20 and a coupling unit 25. The liquid ejecting head 20 ejects the ink supplied from the liquid container 3 via the distribution flow path 17 onto the print medium M. The liquid ejecting head 20 in the present embodiment includes a valve mechanism unit 27. The valve mechanism unit 27 has a valve mechanism for controlling opening and closing of the flow path of the ink supplied through the distribution flow path 17. The valve mechanism unit 27 is provided to project from a side surface of the liquid ejecting head 20 in the X direction. An introduction needle 28 protrudes from the bottom surface of the valve mechanism unit 27 downward in the Z direction, that is, toward the nozzle forming surface of the liquid ejecting head 20. The introduction needle 28 is inserted into an inside of the distribution flow path 17 similarly disposed on the side surface of the liquid ejecting head 20. The flow path in the distribution flow path 17 and the flow path in the valve mechanism unit 27 communicate with each other through the introduction needle 28. Alternatively, a configuration may be adopted in which the introduction needle 28 protrudes upward from the valve mechanism unit 27, that is, to a side opposite to the nozzle forming surface, and is inserted into the distribution flow path 17 disposed above the valve mechanism unit 27.

The head holding member 13 (in the present embodiment, the second head holding member 13B) is a plate-like member that supports the respective liquid ejecting heads 20 that constitute the liquid ejecting module 18. The plurality of liquid ejecting heads 20 aligned in the Y direction constitute a head group 29 and head groups 29 are disposed in two rows in the X direction, and fixed to the head holding member 13. In the present embodiment, each head group 29 is constituted by three liquid ejecting heads 20, and two head groups 29 are fixed to the head holding member 13. Of course, the number of liquid ejecting heads 20 constituting the head group 29 and the number of head groups 29 fixed to the head holding member 13 are not limited to those in the present embodiment. In the present embodiment, the three liquid ejecting heads 20 constituting the head group 29 are referred to as a first liquid ejecting head 20A, a second liquid ejecting head 20B, and a third liquid ejecting head 20C.

An opening portion 30 corresponding to each liquid ejecting head 20 is formed in the head holding member 13. The opening portion 30 is provided to penetrate the head holding member 13 in a thickness direction (that is, the Z direction). In detail, the opening portion 30 has an opening area such that a side of the liquid ejecting head 20 on a nozzle formation surface described later and provided with the nozzles 35 from which the ink droplet is discharged can be inserted. Further, the opening portions 30 are provided independently corresponding to the respective liquid ejecting heads 20. That is, two rows of three opening portions 30 aligned in the Y direction are provided in the X direction corresponding to the liquid ejecting heads 20. The nozzle forming surfaces of the plurality of liquid ejecting heads 20 aligned in the X direction may be exposed from one common opening portion 30.

The liquid ejecting head 20 is fixed to the head holding member 13 in a state where the nozzle forming surface is inserted into the opening portion 30 from an upper surface side of the head holding member 13, that is, a side opposite to the print medium M side in a printing operation. That is, the nozzle forming surface of the liquid ejecting head 20 is exposed from the head holding member 13 to the print medium M side through the opening portion 30 in the printing operation. In this state, the liquid ejecting head 20 is screwed to the head holding member 13.

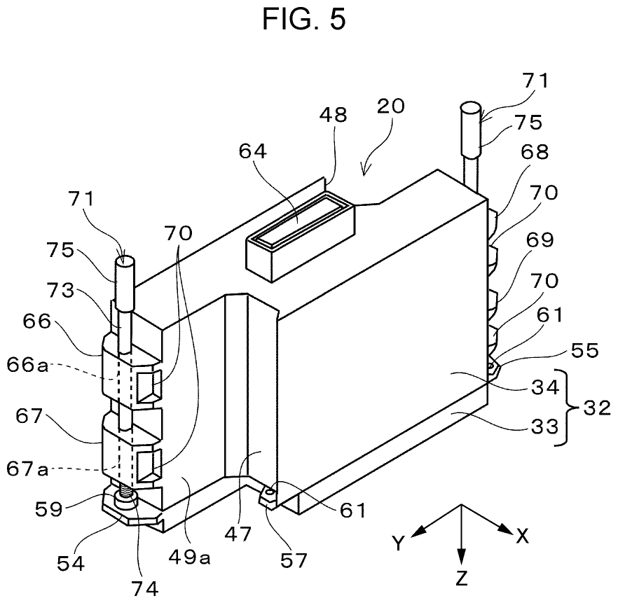

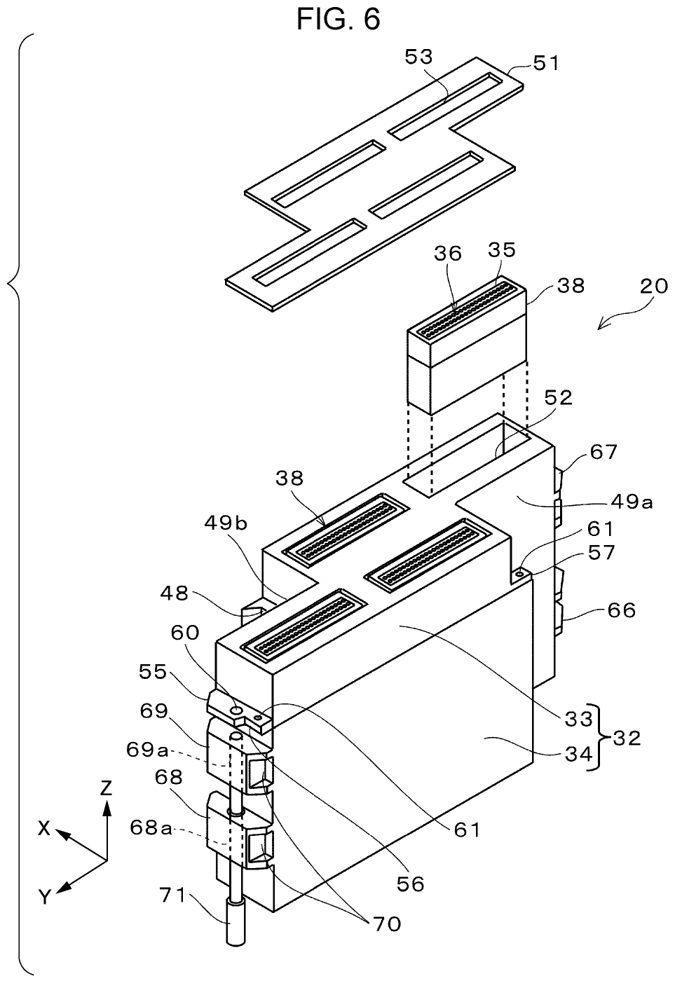

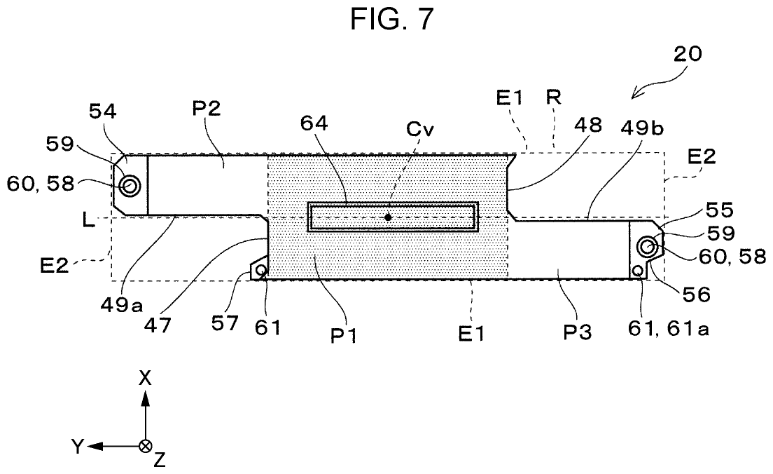

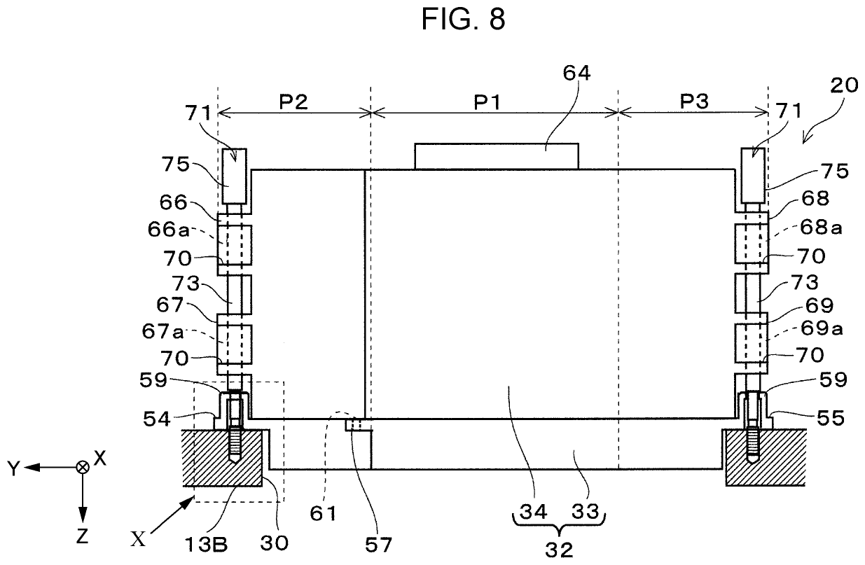

FIG. 5 is a perspective view of the liquid ejecting head 20 viewed obliquely from above, FIG. 6 is an exploded perspective view of the liquid ejecting head 20 viewed obliquely from below, FIG. 7 is a top view of the liquid ejecting head 20, and FIG. 8 is a side view of the liquid ejecting head 20. In FIG. 7, illustration of projection portions 66, 67, 68, and 69, and fastening screws 71 which are described later is omitted. The liquid ejecting head 20 includes a head case 32 formed of a first case 33 and a second case 34 stacked in the Z direction. In the present embodiment, the first case 33 is disposed on a lower side, and the second case 34 is disposed on an upper side in the Z direction that is the first direction in the present disclosure. As illustrated in FIG. 6, a plurality of drive sections 38 are accommodated in the first case 33. The drive section 38 has a nozzle plate 36 is formed, on which the nozzle 35 for discharging the ink toward the print medium M in the Z direction in a state where the liquid ejecting unit 2 stops.

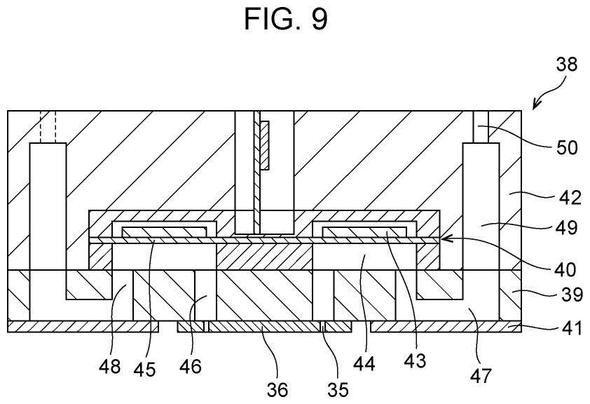

FIG. 9 is a sectional view for explaining an example of the configuration of the drive section 38. The drive section 38 in the present embodiment is unitized by staking a plurality of configuration members such as the nozzle plate 36, a communication plate 39, an actuator substrate 40, a compliance substrate 41, and a holder 42, and joining them with an adhesive or the like.

The actuator substrate 40 in the present embodiment includes a plurality of pressure chambers 44 respectively communicating with the plurality of nozzles 35 formed in the nozzle plate 36, and a plurality of piezoelectric elements 43 provided corresponding to the respective pressure chambers 44. The piezoelectric element 43 is an energy generating element that generates pressure fluctuation in the ink inside the corresponding pressure chamber 44, that is, energy necessary for ejecting the ink from the nozzle 35 communicating with the pressure chamber 44, and is a pressure generating element. A vibration plate 45 is provided between the pressure chamber 44 and the piezoelectric element 43, and an upper opening of the pressure chamber 44 is sealed by the vibration plate 45, and a part of the pressure chamber 44 is partitioned. The piezoelectric elements 43 are respectively stacked in regions corresponding to the respective pressure chambers 44 on the vibrating plate 45. The piezoelectric element 43 in the present embodiment is formed, for example, by sequentially stacking a lower electrode layer, a piezoelectric layer, and an upper electrode layer (all not illustrated) on the vibrating plate 45. The piezoelectric element 43 configured in this manner is bent and deformed when an electric field corresponding to a potential difference between the lower and upper electrode layers is applied.

The communication plate 39 having an area larger than that of the actuator substrate 40 in plan view as viewed in a substrate stacking direction is joined to the lower surface of the actuator substrate 40. In the communication plate 39 in the present embodiment, a nozzle communication port 46 causing the pressure chamber 44 to communicate with the nozzle 35, a common liquid chamber 47 commonly provided for the respective pressure chambers 44, and an individual communication port 48 causing the common liquid chamber 47 to communicate with the nozzle 44 are formed. The common liquid chamber 47 is a space extending in a direction in which the nozzles 35 are aligned. In the present embodiment, two common liquid chambers 47 are formed corresponding to two rows of nozzles 35 provided in the nozzle plate 36. A plurality of individual communication ports 48 are formed corresponding to the respective pressure chambers 44 in the nozzle row direction. The individual communication port 48 communicates with an end portion of the pressure chamber 44 on a side opposite to a portion communicating with the nozzle communication port 46.

The nozzle plate 36 formed with the plurality of nozzles 35 is joined to a substantially central portion of the lower surface of the communication plate 39. The nozzle plate 36 in the present embodiment is a plate member having an outer shape smaller than the communication plate 39 in plan view. The nozzle plate 36 is joined to the lower surface of the communication plate 39 by an adhesive or the like at a position out of the opening of the common liquid chamber 47 and in an area where the nozzle communication port 46 is open, in a state where the nozzle communication port 46 and the plurality of nozzles 35 communicate with each other. In the nozzle plate 36 in the present embodiment, a total of two nozzle rows in which the plurality of nozzles 35 are aligned is formed. Further, the compliance substrate 41 is joined to the lower surface of the communication plate 39 at a position deviated from the nozzle plate 36. The compliance substrate 41 seals the opening of the common liquid chamber 47 on the lower surface of the communication plate 39 in a state of being positioned and joined to the lower surface of the communication plate 39. The compliance substrate 41 has a function of alleviating a pressure fluctuation in the ink flow path, particularly in the common liquid chamber 47.

The actuator substrate 40 and the communication plate 39 are fixed to the holder 42. Introduction liquid chambers 49 communicating with the common liquid chambers 47 in the communication plate 39 are formed on both sides of the actuator substrate 40 inside the holder 42. Further, an inlet 50 communicating with each introduction liquid chamber 49 is open on the upper surface of the holder 42. The inlet 50 communicates with the valve mechanism unit 27.

Therefore, the ink sent from the valve mechanism unit 27 is introduced into the inlet 50, the introduction liquid chamber 49, and the common liquid chamber 47, and is supplied from the common liquid chamber 47 to each pressure chamber 44 through the individual communication port 48. In the drive section 38 configured as described above, the piezoelectric element 43 is driven in a state where the inside of the flow path from the introduction liquid chamber 49 to the nozzle 35 through the common liquid chamber 47 and the pressure chamber 44 is filled with ink. Therefore, the pressure fluctuation occurs in the ink in the pressure chamber 44, and the ink is ejected from a predetermined nozzle 35 by the pressure fluctuation (in other words, pressure vibration). The drive section 38 is not limited to the illustrated configuration, and various known configurations can be adopted. For example, the energy generating element may use one in which a volume of the flow path is changed by deformation of a piezoelectric actuator having a piezoelectric material having an electromechanical conversion function to cause a pressure of the ink in the flow path to change to discharge ink droplets from the nozzle 35, one in which a heating element is disposed in the flow path to cause ink droplets to be ejected from the nozzle 35 by bubbles generated by the heat of the heating element, or a so-called electrostatic actuator or the like in which an electrostatic force is generated between the vibration plate and the electrode to cause the vibration plate to be deformed by the electrostatic force to discharge the ink droplets from the nozzle 35.

As illustrated in FIG. 6, a plurality (four in the present embodiment) of drive sections 38 are disposed in the Y direction and held by the head case 32 in a posture in which the nozzle row direction is the Y direction, and in a state where positions thereof in the X direction are alternately shifted (in other words, alternate states). That is, two rows of drive sections 38 aligned in the Y direction are aligned in the X direction, and the two rows of drive sections 38 are disposed by being shifted by a predetermined pitch in the Y direction. The nozzles 35 of the drive sections 38 are disposed so as to partially overlap in the Y direction by disposing the drive sections 38 alternately in the Y direction in this manner.

Therefore, the rows of the nozzles 35 can be continuously formed in the Y direction.

According to the disposition of the drive sections 38, as illustrated in FIG. 7, the outer shape of the liquid ejecting head 20 is defined when viewed in the Z direction, that is, viewed in plan view in the Z direction. In the present embodiment, since an outermost periphery of the liquid ejecting head 20 is an outer periphery of the head case 32, the outer shape of the liquid ejecting head 20 matches the outer shape of the head case 32. Specifically, as illustrated in FIG. 7, when the liquid ejecting head 20 is viewed in plan view in the Z direction that is the first direction, if a virtual rectangle of a smallest area including the liquid ejecting head 20 is denoted by R, a long side E1 of the rectangle R overlaps a side of the head case 32 in the Y direction, and a short side E2 of the rectangle R overlaps a side of the head case 32 in the X direction. A center line (that is, a virtual center line) passing through a center Cv (that is, a virtual center) of the rectangle R and being parallel to the long side E1 of the rectangle R is L.

A shape of the head case 32 in plan view includes a first portion P1 (hatched portion in FIG. 7) which has the center Cv and through which the center line L passes, and a second portion P2 and a third portion P3 through which the center line L does not pass. Dimensions, that is, widths of the second portion P2 and the third portion P3 in the X direction are set to be slightly smaller than half of a dimension (in other words, a width) of the first portion P1 in the X direction. The second portion P2 is biased to one side (upper side in FIG. 7) in the X direction from the center line L on one side (left side in FIG. 7) of the first portion P1 in the Y direction. The third portion P3 is biased to the other side (lower side in FIG. 7) in the X direction from the center line L on the other side (right side in FIG. 7) of the first portion P1, and is diagonally opposite to the second portion P2 across the center Cv. The liquid ejecting head 20 according to the present embodiment has a substantially point symmetric shape with Cv as the center, which is obtained by cutting a pair of corners on a diagonal line to have a substantially rectangular shape from a rectangle, that is, the rectangle R as a reference shape in plan view in the Z direction. When the drive sections 38 are alternately disposed in the Y direction as described above, the drive sections 38 can be disposed in the second portion P2 and the third portion P3 by providing the second portion P2 and the third portion P3 so as to protrude from both sides in the X direction. Therefore, in the liquid ejecting heads 20 adjacent to each other when the liquid ejecting heads 20 are aligned in the Y direction, the drive section 38 in the third portion P3 of one liquid ejecting head 20 and, the drive section 38 in the second portion P2 of the other liquid ejecting head 20 can be disposed at positions overlapping each other in the X direction, and the row of a series of nozzles 35 disposed in a straight line in the Y direction by a plurality of liquid ejecting heads 20 can be formed.

As illustrated in FIG. 6, the first case 33 is formed with an accommodating portion 52 having a recess shape that opens to the lower surface of the first case 33, and a plurality of drive sections 38 fixed to the fixing plate 51 are accommodated in the accommodating portion 52. Further, the opening of the accommodating portion 52 is sealed by the fixing plate 51. That is, the drive section 38 is accommodated in a space formed by the fixing plate 51 and the accommodating portion 52. In addition, the accommodating portion 52 may be provided for each drive section 38, and may be provided in common over the plurality of drive sections 38. The fixing plate 51 is made of, for example, a metal plate-like member, and an exposure opening portion 53 for exposing the nozzle plate 36 of the drive section 38 is provided at a position corresponding to each drive section 38. In the present embodiment, the exposure opening portion 53 is provided independently for each drive section 38. The fixing plate 51 is fixed to the nozzle plate 36 or the compliance substrate 41 of the drive section 38 at a peripheral edge of the exposure opening portion 53. In the present embodiment, the lower surface of the fixing plate 51, that is, a surface facing the print medium M in the printing operation, and an exposed surface of the nozzle plate 36 in the exposure opening portion 53 of the fixing plate 51 correspond to the nozzle forming surface in the present disclosure.

Further, as illustrated in FIG. 7, a first flange portion 54 protruding outward in the Y direction is provided at an end portion of the first case 33 on a side opposite to the first portion P1 side in the Y direction corresponding to the second portion P2. A cylindrical portion 59 protrudes from the upper surface of the first flange portion 54, that is, the surface on the side opposite to the nozzle forming surface in the Z direction, and a screw hole 60 is formed inside the cylindrical portion 59 in a state of penetrating the first flange portion 54 and the cylindrical portion 59 in the Z direction. Therefore, the screw hole 60 has openings at one side in the Z direction, that is, the nozzle forming surface side, and the other side, that is, a side opposite to the nozzle forming surface side. Further, a second flange portion 55 protruding outward in the Y direction is provided at an end portion of the first case 33 on a side opposite to the first portion P1 side in the Y direction corresponding to the third portion P3. Similar to the first flange portion 54, a cylindrical portion 59 protrudes from the upper surface of the second flange portion 55, and a screw hole 60 is formed inside the cylindrical portion 59 in a state of penetrating the second flange portion 55 and the cylindrical portion 59 in the Z direction. The screw hole 60 is a type of screw hole in the present disclosure, and also a type of through-hole.

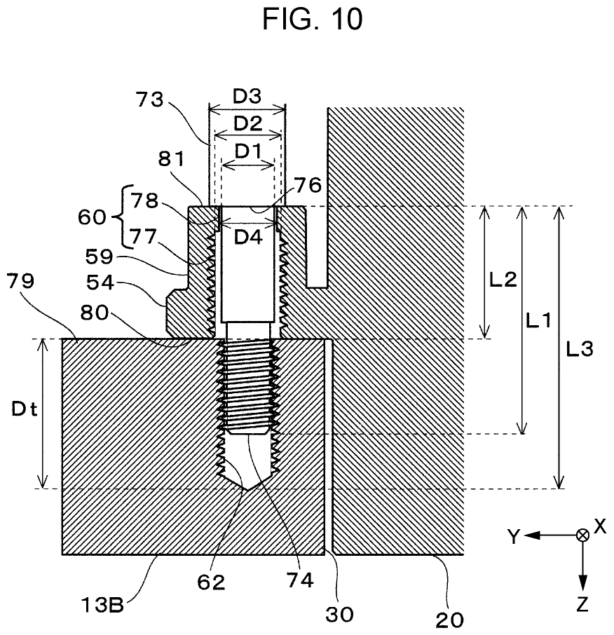

In the second head holding member 13B in the present embodiment, a fixing screw hole 62 is formed up to a middle of the head holding member 13 in the plate thickness direction from the upper surface (in other words, a holding surface 79 on which the liquid ejecting head 20 is held) in the Z direction to the lower surface, at a position corresponding to the screw hole 60, that is, overlapping the screw hole 60 when viewed in the Z direction in a state where the liquid ejecting head 20 is positioned (see FIG. 10). The fixing screw hole 62 may penetrate the head holding member 13 in the Z direction. On the other hand, in the first head holding member 13A described later, an insertion hole 86 penetrating the first head holding member 13A in the plate thickness direction in the Z direction is formed at a position corresponding to the screw hole 60. Then, in the present embodiment, when the liquid ejecting head 20 is fixed to the second head holding member 13B, the fastening screw 71, which is described later, is inserted into the screw hole 60 from the opening on the upper surface side of the cylindrical portion 59, that is, the other side of the screw hole 60, and is screwed into the fixing screw hole 62. Therefore, the liquid ejecting head 20 can be fixed to the second head holding member 13B.

As described above, the flange portions 54 and 55 are respectively formed, and the screw holes 60 are correspondingly formed at the end portion of the second portion P2 and the end portion of the third portion P3. Therefore, a distance between the centers of the screw holes 60 at both end portions can be made longer. Thus, the liquid ejecting head 20 in the head holding member 13 can be disposed with higher accuracy. In particular, in the configuration in which the plurality of liquid ejecting heads 20 are fixed to the head holding member 13, a relative position of the nozzles 35 of each liquid ejecting head 20 can be defined with higher accuracy. Further, the flange portions 54 and 55 which are portions provided with the screw holes 60 do not protrude from a main body of the liquid ejecting head 20 in the X direction that is the short side direction of the liquid ejecting head 20. Therefore, when the plurality of liquid ejecting heads 20 are aligned in the Y direction that is the long side direction, the flange portions 54 and 55 contribute to the reduction in size of the liquid ejecting module 18 and the liquid ejecting unit 2 including the liquid ejecting module 18 in the X direction.

The second flange portion 55 is different from the first flange portion 54 in that the second flange portion 55 has a notch portion 56 in which a portion corresponding to a corner of the rectangle R is cut, and the positioning hole 61 is formed in a region between the notch portion 56 and the main body of the first case 33, in a state of penetrating the second flange portion 55 in the Z direction. A third flange portion 57 is formed on a side opposite to the notch portion 56 of the second flange portion 55 with the first portion P1 in between in the Y direction, that is, one side of the first portion P1. In the third flange portion 57, a positioning hole 61 paired with the positioning hole 61 of the second flange portion 55 is formed in a state of penetrating the third flange portion 57 in the Z direction. Further, a positioning through-hole 63 is formed in the head holding member 13 at a position corresponding to the positioning hole 61 in a state of penetrating in the Z direction (see FIG. 4). When the liquid ejecting head 20 is fixed to the head holding member 13, for example, a positioning pin (not illustrated) provided on a jig or the like is inserted into the positioning through-hole 63 and the positioning hole 61, so that the position of the liquid ejecting head 20 relative to the head holding member 13 can be defined, that is, positioned. A configuration may be adopted in which a positioning pin is erected instead of one of the positioning hole 61 and the corresponding positioning through-hole 63, and positioning is performed by inserting the positioning pin into the hole on the other side.

Here, the notch portion 56 of the second flange portion 55 has a shape that follows the shape of the third flange portion 57 in plan view in the Z direction. More specifically, the shape of the notch portion 56 is similar to the shape of the third flange portion 57 and is set to a shape slightly larger in size. Therefore, in the liquid ejecting heads 20 adjacent to each other when the liquid ejecting heads 20 are aligned in the Y direction, the third flange portion 57 in one liquid ejecting head 20 is disposed in the notch portion 56 of the second flange portion 55 in the other liquid ejecting head 20, so that the liquid ejecting heads 20 can be disposed in the Y direction without interference between the flange portions.

These flange portions 54, 55, and 57 are provided on the second case 34 side opposite to the nozzle forming surface side of the first case 33 in the Z direction. The flange portions 54, 55, and 57 are provided to protrude up to positions outside a region where the opening portion 30 is formed when the nozzle forming surface of the liquid ejecting head 20 is inserted into the opening portion 30 of the head holding member 13. Therefore, when the nozzle forming surface of the liquid ejecting head 20 is inserted into the opening portion 30 of the head holding member 13, the flange portions 54, 55, and 57 abut against the upper surface of the head holding member 13, so that the position of the ejecting head 20 relative to the head holding member 13 in the Z direction is defined.

Wiring electrically coupled to the piezoelectric element 43 of the drive section 38, a flow path for supplying the ink to the drive section 38, and the like are formed inside the second case 34. A filter for removing dust and bubbles contained in the ink, a pressure adjusting unit including an opening/closing valve for maintaining the pressure of the ink supplied to the drive section 38 constant, or the like may be provided inside the second case 34. In the present embodiment, a coupling portion 64 to which external wiring is coupled protrudes on the upper surface of the second case 34 on a side opposite to the nozzle forming surface in the Z direction.

In addition, a first protruding portion 66 and a second protruding portion 67 having the same shape as that of the first flange portion 54 in plan view in the Z direction are aligned with intervals therebetween in the Z direction at the end portion of the second case 34 on one side in the Y direction, that is, the end portion of a portion corresponding to the second portion P2. Further, the first protruding portion 66 and the second protruding portion 67 are formed thicker in the Z direction than the first flange portion 54. Cut-out portions 70 cut in a recess shape are provided on both sides of the first protruding portion 66 and the second protruding portion 67 in the X direction. Similarly, at the end portion of the second case 34 on the other side in the Y direction, that is, at the end portion of a portion corresponding to the third portion P3, a third protruding portion 68 and a fourth protruding portion 69 are aligned with intervals from a Z2 side toward a Z1 side, the third protruding portion 68 and the fourth protruding portion 69 and the first protruding portion 66 and the second protruding portion 67 are left and right symmetrical with respect to the Y direction in plan view in the Z direction. Similar to the first protruding portion 66 and the second protruding portion 67, the third protruding portion 68 and the fourth protruding portion 69 are formed thicker than the second flange portion 55 in the Z direction, and the cut-out portions 70 are provided on both sides in the X direction.

That is, the first flange portion 54, the first protruding portion 66, and the second protruding portion 67 are provided to protrude on one side of the head case 32 in the Y direction, and the second flange portion 55, the third protruding portion 68, and the fourth protruding portion 69 are provided to protrude on the other side of the head case 32 in the Y direction. In the following, the first flange portion 54, the second flange portion 55, the first protruding portion 66, the second protruding portion 67, the third protruding portion 68, and the fourth protruding portion 69 are appropriately referred to as protruding portions.

In the present embodiment, one fastening screw 71 is mounted on each end portion of the head case 32 in the Y direction. In the present embodiment, the fastening screw 71 on one side is inserted into a screw insertion hole 66a, a screw insertion hole 67a, and the screw hole 60 which are provided to respectively penetrate the first protruding portion 66, the second protruding portion 67, and the first flange portion 54 in the Z direction provided on the one side of the head case 32 in the Y direction. The fastening screw 71 on the other side is inserted into a screw insertion hole 68a, a screw insertion hole 69a, and the screw hole 60 which are provided to respectively penetrate the third protruding portion 68, the fourth protruding portion 69, and the second flange portion 55 in the Z direction provided on the other side of the head case 32 in the Y direction. As described later, when the liquid ejecting head 20 is fixed to the first head holding member 13A having no fixing screw hole 62, the fastening screw 71 is not used. The fastening screw 71 in the present embodiment includes a shaft portion 73, a male screw portion 74 provided on a tip end side of the shaft in the Z direction and screwed into the fixing screw hole 62 of the head holding member 13, and a knob portion 75 provided on a base end side in the Z direction and having an outer diameter larger than that of the shaft portion 73.

The shaft portion 73 and the male screw portion 74 of the fastening screw 71 provided on the one side of the head case 32 in the Y direction have outer diameters smaller than the screw insertion hole 66a and the screw insertion hole 67a. The knob portion 75 has an outer diameter larger than the screw insertion hole 66a and the screw insertion hole 67a. Similarly, the shaft portion 73 and the male screw portion 74 of the fastening screw 71 provided on the other side of the head case 32 in the Y direction have outer diameters smaller than the screw insertion hole 68a and the screw insertion hole 69a. The knob portion 75 has an outer diameter larger than the screw insertion hole 68a and the screw insertion hole 69a. Further, an outer diameter D3 (see FIG. 10) of the shaft portion 73 is set larger than an outer diameter D1 (see FIG. 10) of the male screw portion 74, and there is a stepped surface between the shaft portion 73 and the male screw portion 74 by a difference in the outer diameter. That is, when the male screw portion 74 is inserted into the screw hole 60, the stepped surface facing a locked surface 81 of the cylindrical portion 59 described later functions as a locking surface 76 abutting and locking against and to the locked surface 81. Therefore, the shaft portion 73 in the present embodiment also functions as a head portion of the screw in the present disclosure.

FIG. 10 is an enlarged view of a region A in FIG. 8. In FIG. 10, a peripheral structure in a fixed state with the second head holding member 13B on the first flange portion 54 side is illustrated, and a peripheral structure on the second flange portion 55 side and the peripheral structure illustrated in the drawing are right and left symmetrical and are substantially the same. As illustrated in FIG. 10, the screw hole 60 is formed in a state of penetrating a portion of the first flange portion 54 in which the cylindrical portion 59 is formed in the Z direction. The screw hole 60 in the present embodiment has a female screw portion 77 and a small diameter portion 78 in a state where they coaxially communicate with each other in the Z direction. The female screw portion 77 is a portion where a female screw (in other words, a valley-shaped groove to which the screw thread of the male screw portion 74 can be fitted) is formed on an inner peripheral surface, opens to a lower surface of the first flange portion 54 on one side in the Z direction, that is, an abutting surface 80 (corresponding to a first abutting portion in the present disclosure) with the head holding member 13, and communicates with the small diameter portion 78 on the other side in the Z direction.

The small diameter portion 78 is a portion of which an inner diameter D4 is set smaller than the inner diameter D2 of the female screw portion 77 and larger than the outer diameter D1 of the male screw portion 74 of the fastening screw 71. An upper end of the small diameter portion 78 opens to an upper surface of the cylindrical portion 59, that is, the locked surface 81 (corresponding to the second abutting portion in the present disclosure) to which the locking surface 76 of the shaft portion 73 of the fastening screw 71 is locked, and communicates with the female screw portion 77 at a lower end thereof. That is, the screw hole 60 is provided with the abutting surface 80 abutting against the holding surface 79 which is an upper surface of the head holding member 13 (first head holding member 13A in the present embodiment) on one side in the Z direction as the first direction, that is, the nozzle forming surface side. The locked surface 81 to which the shaft portion 73 of the fastening screw 71 is locked is provided on the other side of the screw hole 60 in the Z direction, that is, a side opposite to the nozzle forming surface side. The opening of the screw hole 60 in the abutting surface 80 corresponds to the opening on one side in the present disclosure, and the opening in the locked surface 81 corresponds to the opening on the other side in the present disclosure. In such a screw hole 60, inner diameters of the small diameter portion 78 and the female screw portion 77 are larger than the outer diameter of the male screw portion 74 of the fastening screw 71, so that the male screw portion 74 can be inserted therein. That is, the male screw portion 74 of the fastening screw 71 is not screwed into the screw hole 60. A male screw portion 88 of a fixing screw 85 used when fixing the liquid ejecting head 20 to the first head holding member 13A described later is screwed into the screw hole 60. The small diameter portion 78 also functions as a positioning hole in the present disclosure. This point will also be described later.

As illustrated in FIG. 10, a total length L1 of the male screw portion 74 of the fastening screw 71 is longer than a length L2 of the screw hole 60 in the Z direction, and is set shorter than a length L3 of a sum of the length L2 of the screw hole 60 and a depth Dt of the fixing screw hole 62. In the present embodiment, a configuration, in which the male screw is formed only at the tip portion of the male screw portion 74 in the Z direction, that is, the portion to be inserted into the fixing screw hole 62, is illustrated but the present disclosure is not limited thereto. The male screw (in other words, the screw thread to be fitted to a valley of the female screw) may be formed from a base end (that is, an end on the shaft portion 73 side) of the male screw portion 74 to the tip thereof. When the liquid ejecting head 20 is fixed to the second head holding member 13B, the fastening screw 71 is inserted sequentially from the upper side (that is, the side opposite to the nozzle forming surface side) in the Z direction into the screw insertion holes 66a and 67a of the protruding portions 66 and 67 from the male screw portion 74 side, and is inserted into the screw hole 60 from the opening of the screw hole 60 on the other side in the Z direction in the first flange portion 54. The male screw portion 74 inserted into the screw hole 60 is screwed into the fixing screw hole 62 of the head holding member 13 and the fastening screw 71 is rotated clockwise in plan view in the Z direction and tightened. Therefore, the first flange portion 54 is in a pinched state between the locking surface 76 and the holding surface 79. Similarly, the second flange portion 55 is in a pinched state between the locking surface 76 and the holding surface 79 by being screwed with the fastening screw 71 on the other side in the Y direction. Therefore, the liquid ejecting head 20 is fixed to the first head holding member 13A. That is, the liquid ejecting head 20 in the present embodiment is fixed to the head holding member 13 by the two fixing screws 71 provided on both sides in the Y direction. In the fixed state, the liquid ejecting head 20 (more specifically, the flange portions 54 and 55) is pinched by the head portion of the fastening screw 71, that is, the locking surface 76 of the shaft portion 73 and the second head holding member 13B.

In the present embodiment, the fastening screw 71 is exemplified as an example of a screw, a second screw, or a screw of the second standard used when fixing the liquid ejecting head 20 to the second head holding member 13B, but the present disclosure is not limited thereto. A fixing member having various configurations can be used as long as the fixing member includes a head portion that can be screwed into the fixing screw hole 62 of the second head holding member 13B and can be locked to the locked surface 81 which is the second abutting portion. For example, although the fastening screw 71 in the present embodiment is configured to be inserted into the screw insertion holes 66a to 69a of the respective protruding portions 66 to 69, in the liquid ejecting head having a configuration without the protruding portion, a configuration, in which the fastening screw 71 is not inserted into the protruding portion, can be adopted. Further, the fastening screw 71 in the present embodiment may not have the knob portion 75. In this case, it is also possible to adopt a configuration in which plus, minus, or hexagonal hole is provided in the head portion, and a tool such as a driver is fitted to the hole to turn the screw. Moreover, although the abutting surface 80 and the locked surface 81 are illustrated as the first abutting portion and the second abutting portion, the present disclosure is not limited thereto. For example, it is possible to adopt a configuration in which three or more protrusions abut against the head portion of the screw and the head holding member as long as a surface can be defined.

Next, a case where the liquid ejecting head 20 is fixed to the first head holding member 13A will be described.

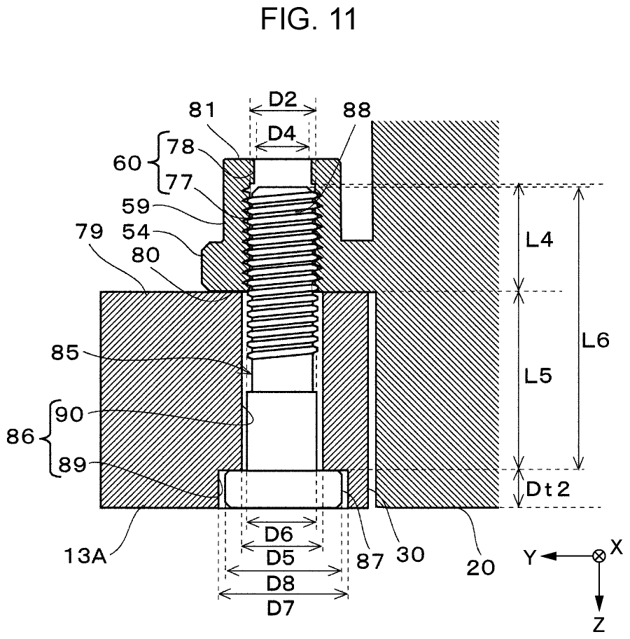

FIG. 11 is a sectional view illustrating a peripheral structure of the first flange portion 54 when the liquid ejecting head 20 is fixed to the first head holding member 13A. The same components as those in FIG. 10 are denoted by the same reference numerals, and the description thereof will be omitted as appropriate. Also in the same drawing, similar to FIG. 10, the peripheral structure of the first flange portion 54 is illustrated, and the peripheral structure on the second flange portion 55 side and the peripheral structure illustrated in the drawing are right and left symmetrical and are substantially the same. In the first head holding member 13A, the insertion hole 86 is formed in a state of penetrating in the plate thickness direction of the first head holding member 13A, that is, in the Z direction at a position corresponding to the fixing screw hole 62 in the second head holding member 13B. That is, the insertion hole 86 is formed at a position overlapping the screw hole 60 when viewed in the Z direction. The insertion hole 86 has an insertion portion 90 set to an inner diameter D5 larger than the inner diameter D2 of the female screw portion 77 of the screw hole 60 and the outer diameter D6 of the male screw portion 88 of the fixing screw 85, and a recess portion 89 set to an inner diameter D7 larger than the inner diameter D5 of the insertion portion 90 and the outer diameter D8 of the head portion 87 of the fixing screw 85. The fixing screw 85 that can be screwed into the screw hole 60 of the liquid ejecting head 20 can be inserted into the insertion hole 86.

The recess portion 89 is formed on the lower surface (that is, a surface that constitutes a part of the nozzle forming surface) on the side opposite to the holding surface 79 for holding the liquid ejecting head 20 in the first head holding member 13A, and is configured such that the head portion 87 of the fixing screw 85 inserted into the insertion hole 86 is accommodated from one side, that is, the nozzle forming surface side to the holding surface 79 side on the other side in the Z direction. The recess portion 89 is formed in a state of being recessed from the lower surface of the first head holding member 13A by a depth Dt2 in the thickness direction of the first head holding member 13A, which is the Z direction, and is hollow having, for example, a circular shape in plan view viewed in the Z direction. The shape of the recess portion 89 in plan view is not limited to the circle, as long as the head portion 87 has a shape capable of rotating around the axis of the male screw portion 88 in the recess portion 89 when the male screw portion 88 of the fixing screw 85 is inserted into the insertion hole 86 and screwed into the screw hole 60 or when the male screw portion 88 is removed from the screw hole 60. The depth Dt2 of the recess portion 89 is set to be substantially the same as or thicker than the thickness of the head portion 87 in the Z direction. On the other hand, the insertion portion 90 is a through-hole which penetrates from the bottom portion of the recess portion 89 to the holding surface 79 in the Z direction with a constant inner diameter D5, and is disposed coaxially with the recess portion 89. In addition, the shape of the head portion 87 in plan view can adopt a shape such as a circle or a hexagon. The other configurations of the first head holding member 13A is the same as those of the second head holding member 13B.

The fixing screw 85 is a screw capable of being screwed into the screw hole 60 of the liquid ejecting head 20, and has the male screw portion 88 and the head portion 87. The fixing screw 85 is a screw, an outer diameter D6 of the male screw portion 88 being larger than the outer diameter D1 of the male screw portion 74 of the fastening screw 71. For example, the outer diameter (hereinafter also referred to as the thickness appropriately) of the male screw portion defined by the standard of metric screw in Japanese Industrial Standard is different between the fixing screw 85 and the fastening screw 71. More specifically, the fixing screw 85 is a first screw of a first standard defined in the standard, and the fastening screw 71 is a second screw of a second standard of which the outer diameter of the male screw portion is smaller than that of the first standard. That is, when a fixing target of the liquid ejecting head 20 is the first head holding member 13A, the fixing screw 85, which is the first screw of the first standard, is used as the screw in the present disclosure, and when the fixing target of the liquid ejecting head 20 is the second head holding member 13B, the fixing screw 85, which is the first screw of the first standard, is used as the screw in the present disclosure. It is possible to adopt a configuration in which the head portion 87 of the fixing screw 85 is provided with plus, minus, or hexagonal hole, and a tool such as a driver is fitted to the hole to rotate the fixing screw 85 around the axis of the male screw portion 88.

As illustrated in FIG. 11, an entire length of the male screw portion 88 of the fixing screw 85 is set to be longer than the length L4 of the female screw portion 77 of the screw hole 60 in the Z direction and the length L5 of the insertion portion 90 of the insertion hole 86 in the X direction, and slightly shorter than the total length L6 of L4 and L5. When the liquid ejecting head 20 is fixed to the first head holding member 13A, in a state where the liquid ejecting head 20 is positioned in advance to the first head holding member 13A, and the screw hole 60 and the insertion hole 86 communicate with each other, the male screw portion 88 of the fixing screw 85 is inserted into the insertion hole 86 from one side (that is, the nozzle forming surface side) in the Z direction, and the male screw portion 88 inserted into the insertion hole 86 is inserted and screwed from the opening of the screw hole 60 of the liquid ejecting head 20 in the Z direction into the screw hole 60. A state where the abutting surface 80 of the first flange portion 54 abuts against the holding surface 79 of the second head holding member 13B by clockwise rotating and tightening the fixing screw 85 in plan view in the Z direction, that is, a state where the first head holding member 13A is pinched by the first flange portion 54 of the liquid ejecting head 20 and the head portion 87 of the fixing screw 85 is provided. Similarly, on the second flange portion 55 side, the fixing screw 85 is inserted into the insertion hole 86 from one side in the Z direction, and the male screw portion 88 is screwed into the screw hole 60 of the second flange portion 55, so that the first head holding member 13A is in a pinched state by the second flange portion 55 and the head portion 87 of the fixing screw 85. That is, in the present embodiment, one liquid ejecting head 20 is fixed to the first head holding member 13A by two fixing screws 85 provided on both sides in the Y direction.

In the fixed state, the entire head portion 87 of the fixing screw 85 is accommodated in the recess portion 89 so as not to protrude from the lower surface of the first head holding member 13A. Therefore, when the nozzle forming surface is wiped by the wiping member such as the wiper 10, the nozzle forming surface can be smoothly wiped. For example, in a configuration in which the head portion 87 of the fixing screw 85 protrudes below the nozzle forming surface, that is, toward the print medium M in the printing operation, when the wiping member such as the wiper 10 wipes the nozzle forming surface, the head portion 87 comes into contact with the wiping member. Therefore, there is a concern that the wiping cannot be smoothly performed or the wiping member is damaged, but such a defect can be suppressed in the present embodiment. In addition, it is possible to reduce a defect that the ink (also including misted and adhered one when the ink is ejected from the nozzle 35) attached to the nozzle forming surface is collected on the head portion 87 and the collected ink drips from the head portion 87 onto the print medium M or the like. Furthermore, it is possible to reduce a concern for causing so-called jamming with which the print medium M comes in contact with the head portion 87 of the screw 85 and is clogged in the liquid ejecting apparatus.

Further, since the insertion hole 86 is a hole having an inner diameter larger than the inner diameter of the screw hole 60, the insertion hole 86 does not interfere with the fixing screw 85 when the fixing screw 85 is inserted from the insertion hole 86 and screwed into the screw hole 60. That is, for example, in a configuration in which a female screw is formed on the inner peripheral surface of the insertion hole 86 and the male screw portion 88 of the fixing screw 85 is screwed into both the female screw and the screw hole 60, the grooves of the female screw of the insertion hole 86 and the female screw of the screw hole 60 may not be aligned. In this case, it is considered that the liquid ejecting head 20 floats or tilts from the holding surface 79 of the first head holding member 13A by tightening the fixing screw 85. In the present embodiment, the liquid ejecting head 20 can be fixed in a stable posture with respect to the first head holding member 13A without causing such a defect.

As described above, the screw hole 60 which is a through-hole in the liquid ejecting head 20 according to the present disclosure has openings on one side which is the nozzle forming surface side in the Z direction that is the first direction and on the other side which is the side opposite to the nozzle forming surface side. Therefore, when the liquid ejecting head 20 is fixed to the head holding member 13, it is possible to perform the screwing operation in which a screw for fixing to the head holding member 13 is inserted from each of the one side and the other side in the Z direction. That is, when the liquid ejecting head 20 is fixed to the second head holding member 13B having the fixing screw hole 62 at a position overlapping the screw hole 60 in plan view (in other words, when the fixing target of the liquid ejecting head 20 is the second head holding member 13B), the fastening screw 71 is inserted from the opening of the screw hole 60 on the other side, and the male screw portion 74 of the fastening screw 71 is screwed into the fixing screw hole 62. Therefore, the liquid ejecting head 20 can be fixed to the second head holding member 13B, in other words, can be screwed on. Further, when the liquid ejecting head 20 is fixed to the first head holding member 13A having the insertion hole 86 at the position overlapping the screw hole 60 in plan view (in other words, when the fixing target of the liquid ejecting head 20 is the first head holding member 13A), the fixing screw 85 is inserted into the insertion hole 86, and the male screw portion 88 of the fixing screw 85 is inserted from the opening of the screw hole 60 on one side and screwed into the screw hole 60. Therefore, the liquid ejecting head 20 can be fixed to the first head holding member 13A, in other words, can be screwed on. As described above, regardless of the fixing target, since screws can be inserted into the common screw holes 60 to fix the liquid ejecting heads 20 to the head holding members 13A and 13B, respectively, that is, since it is not necessary to use different screw holes in each screwing operation, it contributes to the miniaturization of the liquid ejecting head 20 accordingly.

In the present embodiment, the abutting surface 80 abutting against the head holding member 13 is provided on one side of the screw hole 60 in the Z direction, and the locked surface 81 abutting against the locking surface 76 of the shaft portion 73 functioning as a screw that can be screwed into the fixing screw hole 62 formed in the head holding member 13 (second head holding member 13B in the present embodiment), that is, the head portion of the fastening screw 71 is provided on the other side in the Z direction. Therefore, the flange portions 54 and 55 which are a part of the liquid ejecting head 20 can be pinched between the locking surface 76 of the shaft portion 73 and the second head holding member 13B, and the liquid ejecting head 20 can be stably fixed by the second head holding member 13B. That is, the abutting position between the shaft portion 73 which is the head portion of the fastening screw 71 and the liquid ejecting head 20 is closer to the second head holding member 13B of the fixing target in the Z direction. Therefore, distortion/warpage of the configuration elements of the liquid ejecting head 20 can be suppressed as compared with a configuration in which the abutting position is disposed farther than that of the present embodiment.

Furthermore, in the present embodiment, the size of the opening of the screw hole 60 on the other side is set to a size (that is, the inner diameter D4) such that the male screw portion 74 of the fastening screw 71, which is the second screw of the second standard having an outer diameter of the male screw portion smaller than that of the fixing screw 85 which is the first screw of the first standard capable of being screwed into the screw hole 60, can be inserted, and the shaft portion 73, which is the head portion of the fastening screw 71 can be locked to the locked surface 81 that is the second abutting portion, can be locked. Therefore, falling of the fastening screw 71, the outer diameter D1 of the male screw portion 74 being smaller than the inner diameter D2 of the screw hole 60, into the screw hole 60 is suppressed, and the liquid ejecting head 20 can be firmly fixed to the second head holding member 13B by the fastening screw 71.

As described above, in the liquid ejecting head 20 according to the present disclosure, the standards of the male screw in the screw are different in a case where the head portion of the screw used for fixing to the head holding member 13 is located on one side of the screw hole 60 in the Z direction, that is, on the nozzle forming surface side, and in a case where the head portion thereof is located on the other side of the screw hole 60, that is, on the side opposite to the nozzle forming surface side. That is, it is sufficient to use a standard screw according to whether the screw hole 60 is screwed from which of the one side and the other side in the Z direction by predetermining the thickness of the male screw portion in the standard of the screw. Therefore, the operator is less likely to be confused about the selection of screw size, that is, the thickness and the outer diameter of the male screw portion and workability is further improved.

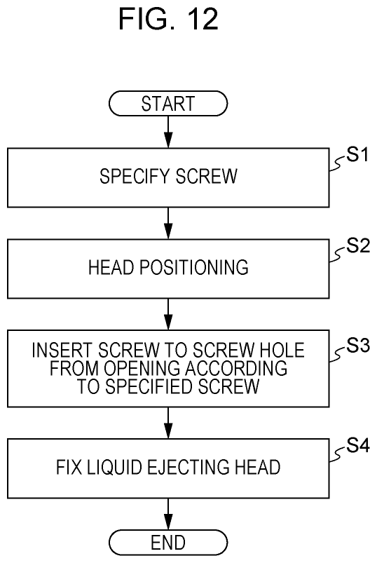

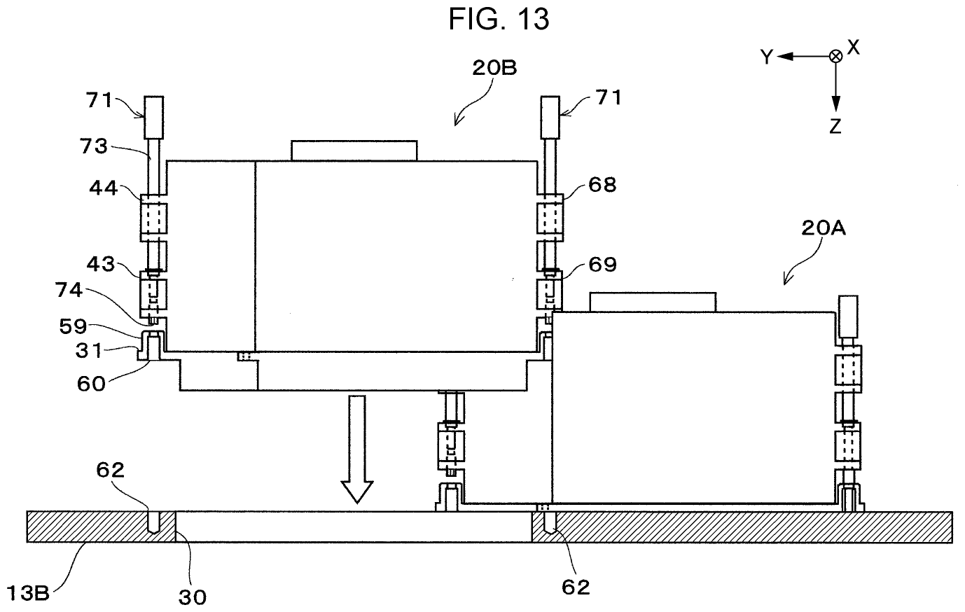

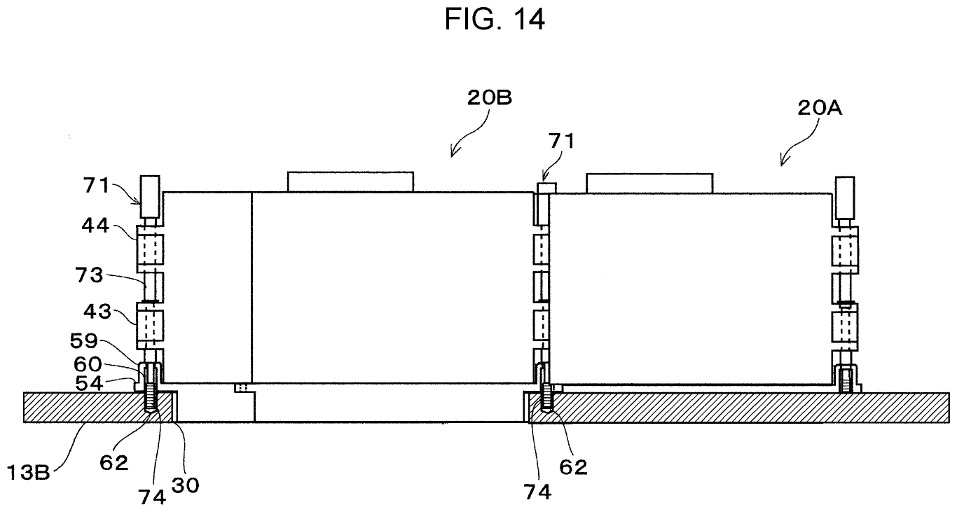

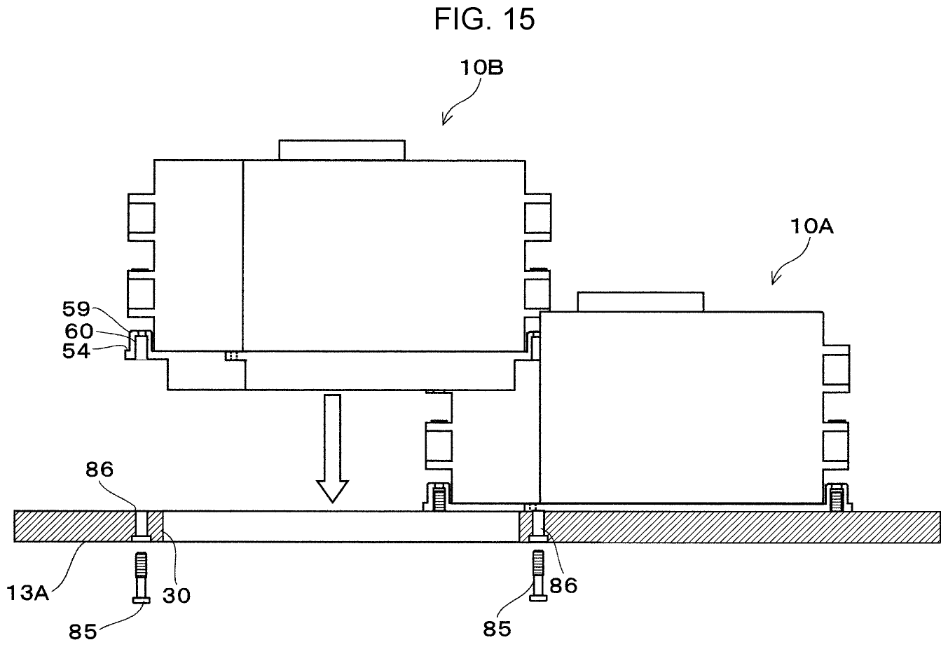

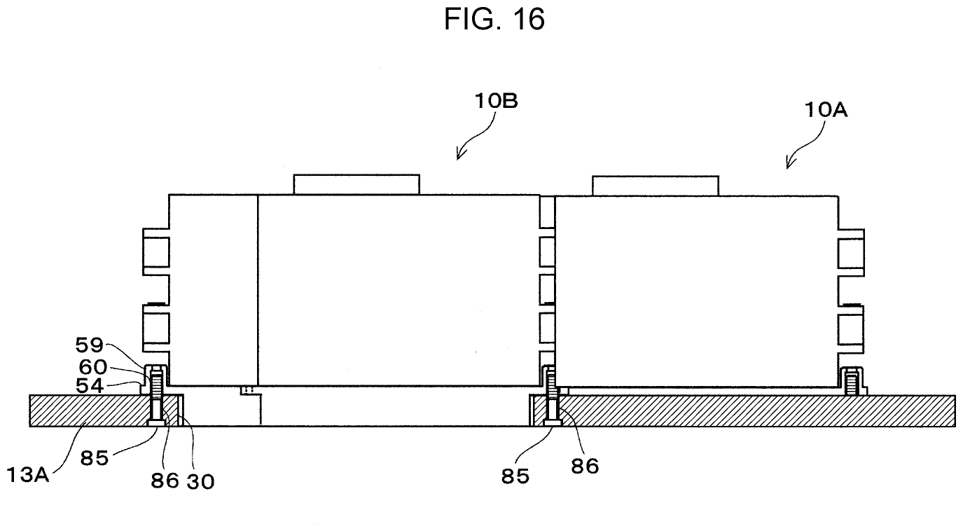

Next, a method of manufacturing the printer 1 in the present embodiment will be described. FIG. 12 is a flow chart for mainly explaining a step of fixing the liquid ejecting head 20 to the head holding member 13 in the method of manufacturing the printer 1, FIGS. 13 and 14 are views for explaining a step of fixing the liquid ejecting head 20 to the second head holding member 13B, and FIGS. 15 and 16 are views for explaining a step of fixing the liquid ejecting head 20 to the first head holding member 13A. FIGS. 13 and 15 illustrate a state where fixing of the first liquid ejecting head 20A to the second head holding member 13B is completed. Therefore, the following explains the step of fixing (that is, screwing) the second liquid ejecting head 20B to the head holding member 13 (13A and 13B) at a position adjacent to the first liquid ejecting head 20A in the Y direction. Moreover, in the following description, FIGS. 10 and 11 are also referred to as appropriate. Furthermore, for the steps and operations common to a case where the fixing target of the liquid ejecting head 20 is the first head holding member 13A and a case where the fixing target thereof is the second head holding member 13B, it is simply described as the head holding member 13 without distinguishing the head holding members 13A and 13B from each other.

When the liquid ejecting head 20 is attached to the head holding member 13, the using screw differs depending on whether the head holding member 13 that is the fixing target is the first head holding member 13A or the second head holding member 13B (in other words, the thickness of the male screw portion defined in the standard is different), so that first, a screw specifying step of specifying the screw corresponding to the head holding member 13 that is the fixing target is performed (S1). For example, when the fixing target of the liquid ejecting head 20 is the second head holding member 13B, the fastening screw 71, which is a type of the second screw of the second standard, is specified as the fixing screw, and when the fixing target of the liquid ejecting head 20 is the first head holding member 13A, the fixing screw 85, which is a type of the first screw of the first standard, is specified as the fixing screw.

Next, a positioning step of determining the disposition position of the liquid ejecting head 20 with respect to the head holding member 13 of the fixing target is performed (S2). The order of step S1 and step S2 may be reversed. In the positioning step, as illustrated in FIGS. 13 and 15, in a state where the nozzle forming surface of the liquid ejecting head 20 disposed on the upper surface of the head holding member 13 faces the opening portion 30 of the head holding member 13, the liquid ejecting head 20 moves downward in the Z direction and is inserted into the opening portion 30 from the nozzle forming surface side. As described above, the position of the liquid ejecting head 20 with respect to the head holding member 13 is roughly defined in the XY plane direction by inserting the nozzle forming surface into the opening portion 30, that is, by disposing the first case 33 into the opening portion 30. In addition, the first flange portion 54, the second flange portion 55, and the third flange portion 57 abut against the holding surface 79 of the peripheral portion of the opening portion 30 of the head holding member 13, so that the position of the liquid ejecting head 20 with respect to the head holding member 13 in the Z direction is defined.

In the positioning step, a positioning pin provided on a positioning jig (not illustrated) is inserted from the lower surface side of the head holding member 13 into the positioning through-hole 63 to protrude from the upper surface of the head holding member 13, and the protruding portion of the positioning pin is inserted into the positioning hole 61 of the liquid ejecting head 20, so that the relative position of the liquid ejecting head 20 with respect to the head holding member 13 in the XY plane direction is defined with higher accuracy. In the positioning state, when the fixing target is the second head holding member 13B, the screw hole 60 of the liquid ejecting head 20 and the fixing screw hole 62 of the second head holding member 13B overlap each other in plan view in the Z direction. When the fixing target is the first head holding member 13A, the screw hole 60 of the liquid ejecting head 20 and the insertion hole 86 of the first head holding member 13A overlap each other in plan view in the Z direction. That is, in the former, the screw hole 60 and the fixing screw hole 62 communicate with each other, and in the latter, the screw hole 60 and the insertion hole 86 communicate with each other.

After the liquid ejecting head 20 is positioned, a screw inserting step is performed (S3) in which the screw is inserted into the screw hole 60 from the opening on the side corresponding to the screw specified in the screw specifying step among the openings on both sides of the screw hole 60 in the Z direction. That is, when the fixing target is the second head holding member 13B, the male screw portion 74 of the fastening screw 71 is inserted into the screw hole 60 from the opening provided in the locked surface 81 on the other side in the Z direction, that is, on a side opposite to the nozzle forming surface side. When the fixing target is the first head holding member 13A, the male screw portion 88 of the fixing screw 85 is inserted into the insertion hole 86 from one side of the first head holding member 13A in the Z direction, and is inserted into the screw hole 60 from the opening of the screw hole 60 on one side in the Z direction. As illustrated in FIGS. 14 and 16, the male screw portion of the screw inserted into the screw hole 60 is screwed and tightened, and whereby the liquid ejecting head 20 is fixed to a predetermined position of the head holding member 13 of the fixing target (step S4). That is, when the fixing target is the second head holding member 13B, the liquid ejecting head 20 is pinched by the locking surface 76 of the shaft portion 73 which is the head portion of the fastening screw 71 and the second head holding member 13B. When the fixing target is the first head holding member 13A, the first head holding member 13A is pinched between the head portion 87 of the fixing screw 85 accommodated in the recess portion 89 and the liquid ejecting head 20.

As described above, when the liquid ejecting head 20 according to the present disclosure is fixed to the head holding member 13, screwing operation can be performed from one side and the other side in the Z direction. Therefore, the screwing operation can be performed from the direction according to the specification and an internal structure of the liquid ejecting apparatus on which the liquid ejecting head 20 is mounted, and the like. Further, even if the screws corresponding to the fixing target of the liquid ejecting head 20 are different (that is, the thicknesses of the male screw portions are different), the liquid ejecting head 20 can be fixed to the head holding member 13 using each screw. In this regard, since the fixing screw is predetermined according to the fixing target of the liquid ejecting head 20, the operator is less likely to be confused about the selection of screws and workability is further improved. The method of manufacturing the liquid ejecting apparatus described above can also be applied to, for example, when repair or replacement of the liquid ejecting head 20 fixed to the head holding member is performed.

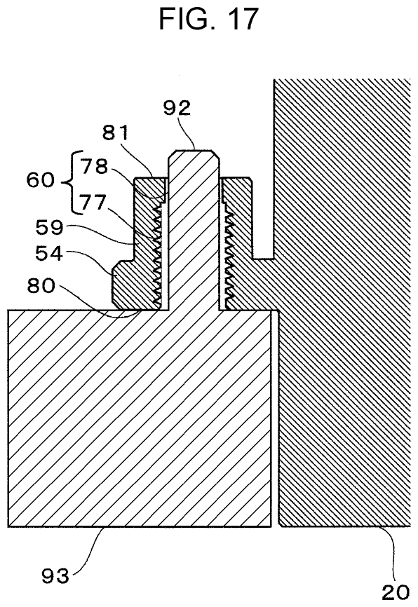

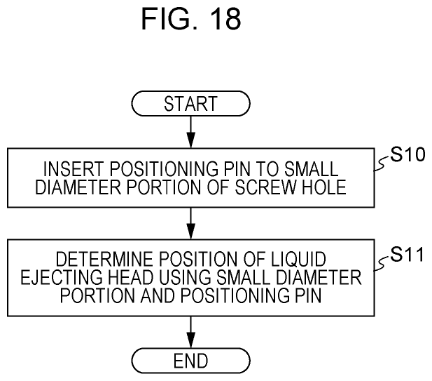

FIG. 17 is a sectional view illustrating a peripheral structure on the first flange portion 54 side for explaining the positioning state of the liquid ejecting head 20 by a positioning jig 93. FIG. 18 is a flow chart for explaining the positioning step of the liquid ejecting head 20 by the positioning jig 93. In FIG. 17, the same components as those in FIG. 10 or 11 are denoted by the same reference numerals, and the description thereof will be omitted as appropriate. Similar to FIGS. 10 and 11, also in the drawing, the peripheral structure of the first flange portion 54 is illustrated, but the peripheral structure on the second flange portion 55 side and the peripheral structure illustrated in the drawing are right and left symmetrical and are substantially the same. Here, in a step before fixing the liquid ejecting head 20 to the head holding member 13, for example, an assembly step of the liquid ejecting head 20 itself, an inspection step of the liquid ejecting head 20, or the like is performed. When the liquid ejecting head 20 is positioned at a predetermined position in each step, it is also conceivable to use the positioning hole 61 described above. However, when the positioning pin is inserted into the positioning hole 61 each time in each step, the positioning pin rubs against an inner wall surface of the positioning hole 61, so that the inner surface of the positioning hole 61 is scraped. Therefore, there is a concern that the positioning accuracy with the head holding member 13 by the positioning hole 61 is reduced.

Therefore, in the liquid ejecting head 20 according to the present disclosure, in a step before fixing the liquid ejecting head 20 to the head holding member 13 (more specifically, a step at least before the screw inserting step), the small diameter portion 78 is used as a positioning hole, so that positioning of the liquid ejecting head 20 can be performed by providing the small diameter portion 78 in the screw hole 60 separately from the positioning hole 61. Therefore, the outer diameter of the positioning pin 92 erected on the positioning jig 93 is set slightly smaller than the inner diameter of the small diameter portion 78. As illustrated in FIGS. 17 and 18, in the positioning step, when the positioning pin 92 erected on the positioning jig 93 is inserted into the small diameter portion 78 of the screw hole 60 from one side (positioning pin inserting step S10), the position of the liquid ejecting head 20 on the XY plane is defined by the outer peripheral surface of the positioning pin 92 and the inner peripheral surface of the small diameter portion 78 (positioning step S11). The position of the liquid ejecting head 20 in the Z direction can be defined by the respective flange portions 54, 55, and 57 abutting against the holding surface of the positioning jig 93. As described above, the positioning of the liquid ejecting head 20 can be performed by providing the small diameter portion 78 in the screw hole 60 separately from the positioning hole 61, using the small diameter portion 78 as a positioning hole. Therefore, it is possible to prevent the positioning accuracy by the positioning hole 61 from being lowered.

Besides the above, the present disclosure can also be applied to other liquid ejecting apparatuses in which the liquid ejecting head is screwed to the head holding member. For example, the present disclosure can be applied to a liquid ejecting head provided with a plurality of color material ejecting heads used to manufacture a color filter such as a liquid crystal display, electrode material ejecting heads used to form an electrode such as an organic electro luminescence (EL) display or a surface emitting display (FED), bio-organic matter ejecting heads used to manufacture a biochip (biochemical element), and the like, and a liquid ejecting apparatus provided with the same.

What is claimed is:

1. A liquid ejecting head comprising:
a nozzle forming surface on which a nozzle ejecting a liquid is formed;
an energy generating element that generates energy for ejecting the liquid from the nozzle; and
a screw hole for fixing to a head holding member that holds the liquid ejecting head, wherein
the screw hole has openings respectively open to one side which is a nozzle forming surface side in a first direction intersecting the nozzle forming surface and to another side opposite to the nozzle forming surface side.

2. The liquid ejecting head according to claim 1, wherein
the one side of the screw hole is provided with a first abutting portion abutting against the head holding member, and
the other side of the screw hole is provided with a second abutting portion abutting against a head portion of a screw configured to be screwed into a fixing screw hole formed in the head holding member.

3. The liquid ejecting head according to claim 1, wherein
a standard of a male screw portion in the screw differs between when a head portion of a screw is located on the one side of the screw hole and when the head portion of the screw is located on the other side of the screw hole.

4. The liquid ejecting head according to claim 1, wherein
a size of the opening on the other side is set to a size such that a male screw portion of a second screw, an outer diameter of the male screw portion being smaller than that of a first screw configured to be screwed into the screw hole, is configured to be inserted into the opening, and a head portion of the second screw is configured to be locked to a second abutting portion.

5. A liquid ejecting head configured to be fixed to a first head holding member having an insertion hole into which a first screw for holding the liquid ejecting head is configured to be inserted, and a second head holding member having a fixing screw hole into which a second screw different from the first screw is configured to be screwed at a position corresponding to the insertion hole, the head comprising:
a nozzle forming surface on which a nozzle ejecting a liquid is formed;
an energy generating element that generates energy for ejecting the liquid from the nozzle; and
a screw hole into which the first screw is configured to be screwed, wherein
the screw hole has openings respectively open to one side which is a nozzle forming surface side in a first direction intersecting the nozzle forming surface and to another side opposite to the nozzle forming surface side.

6. The liquid ejecting head according to claim 5, wherein
the second screw having a male screw portion of which an outer diameter is smaller than that of the first screw, is inserted into the screw hole, and the inserted second screw is configured to be screwed into the fixing screw hole of the second head holding member.

7. A liquid ejecting head configured to be fixed to a first head holding member having an insertion hole into which a first screw of a first standard is configured to be inserted, and a second head holding member having a fixing screw hole into which a second screw of a second standard having a male screw portion of which an outer diameter is smaller than that of the first standard, is configured to be screwed at a position corresponding to the insertion hole, the head comprising:
a nozzle forming surface on which a nozzle ejecting a liquid is formed;
an energy generating element that generates energy for ejecting the liquid from the nozzle; and
a screw hole into which the second screw is configured to be inserted and the first screw is configured to be screwed, wherein
the screw hole has openings respectively open to one side which is a nozzle forming surface side in a first direction intersecting the nozzle forming surface and to another side opposite to the nozzle forming surface side.

8. The liquid ejecting head according to claim 1, wherein
the screw hole has a positioning hole having an inner diameter smaller than an inner diameter of the screw hole.

9. The liquid ejecting head according to claim 1, wherein
in plan view as viewed in the first direction, a first portion of which a center line parallel to a long side of a rectangle having a minimum area including the nozzle forming surface passes a center thereof, and a second portion deviated from the center line, and a third portion diagonally opposite to the second portion with the center in between are arranged in a second direction parallel to the long side, and
the screw hole is provided at each of an end portion of the second portion opposite to the first portion in the second direction, and an end portion of the third portion opposite to the first portion in the second direction.

10. A head holding member to which the liquid ejecting head according to claim 1 is fixed, the member comprising an insertion hole having an inner diameter larger than an inner diameter of the screw hole at a position overlapping the screw hole when viewed in the first direction.

11. The head holding member according to claim 10, wherein
a surface opposite to a surface holding the liquid ejecting head has a recess portion in which a head portion of a screw inserted into the insertion hole and screwed into the screw hole is accommodated.

12. A head holding member to which the liquid ejecting head according to claim 1 is fixed, the member comprising a fixing screw hole which is set to have an inner diameter smaller than an inner diameter of the screw hole at a position overlapping the screw hole when viewed in the first direction, and into which a screw inserted into the screw hole is configured to be screwed.
